(19) United States
(12) Patent Application Publication
(10) Pub. No.: US 2010/0323619 A1
(43) Pub. Date: Dec. 23, 2010

(54) Headset Adapter and Methods for Communicating Between a Hands-Free Headset and a Landline Telephone

(76) Inventor: Donald J. Arndt, San Francisco, CA (US)

Correspondence Address: SHEPPARD, MULLIN, RICHTER & HAMPTON LLP, 990 Marsh Road, Menlo Park, CA, 94025, US

(21) Appl. No.: 12/755,357

(22) Filed: Apr. 6, 2010

Related U.S. Application Data
(60) Provisional application No. 61/219,717, filed on Jun. 23, 2009.

(51) Int. Cl. H04M 9/00; H04B 7/00

(52) U.S. Cl. 455/41.2; 379/420.01

(57) ABSTRACT

A hands-free headset adapter comprises a first telephone connector configured to couple with the base unit of a landline telephone; a second telephone connector configured to couple with the handset of the landline telephone, the second telephone connector coupled to the first telephone connector via a communication channel; receive and transmit circuits coupled to the communication channel and configured to receive and transmit audio information with the base unit of the landline telephone; and a hands-free transceiver coupled to the receive and transmit circuits and configured to communicate over a desired standard, e.g., the Bluetooth® standard, with a hands-free headset. The second connector may be configured to reconnect the original telephone handset, thereby maintaining the original integrity of the desk/wall-mount telephone. The desired standard may include the same wireless standard as a user's cellular telephone.

### PRIORITY CLAIM

This application claims benefit of and hereby incorporates by reference provisional patent application Ser. No. 61/219,717, entitled “Wireless Headset Adapter,” filed on Jun. 23, 2009, by inventor Donald J. Arndt.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This invention relates generally to hands-free headsets, and more particularly provides a headset adapter capable of enabling a cellular or mobile telephone hands-free headset to communicate via wire or wireless connection with a typical landline desk/wall-mount home/office telephone, thereby enabling hands-free operation on the landline telephone.

### BACKGROUND

Cellular telephones have become ubiquitous, substantially because cellular telephones offer users social access without compromising freedom of travel. Generally, users can be anywhere cellular telephone companies provide access.

Hands-free (wired or wireless) headsets with built-in microphones and speakerphones have become quite common among cellular telephone users. Instead of having to hold the cellular telephone against one's ear, a cellular telephone user uses the hands-free headset. While the cellular telephone is nearby, e.g., in the user's pocket, the hands-free headset and cellular telephone communicate, e.g., using Bluetooth® standard protocols. Therefore, the user can communicate hands free over the cellular telephone.

Most typical landline desk/wall-mount home/office telephones do not have the capability of easily connecting to a hands-free headset. Accordingly, systems and methods to enable landline telephones to communicate with hands-free headsets would be helpful.

### SUMMARY

In some embodiments, the present invention provides a landline telephone equipped with a hands-free headset adapter. The headset adapter enables the landline telephone to communicate over a desired standard (e.g., the Bluetooth standard) with a hands-free headset (not shown, not supplied). In some embodiments, the headset adapter enables the landline telephone to communicate with the hands-free headset using the same wireless standard as the hands-free headset communicates with the user's cellular phone (not shown, not supplied). For example, the headset adapter may operate using a Bluetooth® standard. Thus, the Bluetooth®-compliant headset adapter can cooperate with the same Bluetooth®-compliant headset that the user owns for use with his or her Bluetooth®-compliant cellular telephone. In some embodiments, the headset adapter enables the landline telephone to communicate over a wired connection to a wired hands-free headset.

In some embodiments, the present invention provides a hands-free headset adapter comprising a first telephone connector configured to couple with the base unit of a landline telephone; a second telephone connector configured to couple with the handset of the landline telephone, the second telephone connector coupled to the first telephone connector via a communication channel; receive and transmit circuits coupled to the communication channel and configured to receive and transmit audio information with the base unit of the landline telephone; and a hands-free transceiver coupled to the receive and transmit circuits and configured to communicate over a desired standard, e.g., the Bluetooth® standard, with a hands-free headset. A telephone connector may include a 3-position (3P) or 4-position (4P) telephone connector, e.g., a telephone plug or telephone socket, such as an RJ-9 connector. The second connector may be configured to reconnect the original telephone handset, thereby maintaining the original integrity of the desk/wall-mount telephone. The desired standard may include the same wireless standard as a user's cellular telephone. Each of the receive and transmit circuits may include an impedance matching transformer or capacitor-coupled or resistor-coupled amplifier between the base unit and the hands-free transceiver.

In some embodiments, the present invention provides a method comprising using a first connector to couple a hands-free headset adapter to a base unit of a landline telephone, the hands-free headset adapter including receive and transmit circuits and a hands-free transceiver capable of communicating over a desired standard, e.g., the Bluetooth® standard; using a second connector to couple the hands-free headset adapter to the handset of the landline telephone, the second connector coupled to the first connector via a communication channel; capturing first audio information from the communication channel by the receive circuit; communicating second audio information based on the first audio information captured by the receive circuit to the hands-free transceiver; and using the hands-free transceiver to communicate third audio information based on the second audio information over the desired standard to a hands-free headset. A telephone connector may include a 3-position (3P) or 4-position (4P) telephone connector, e.g., a telephone plug or telephone socket, e.g., RJ-9. The second connector may be configured to reconnect the original telephone handset, therefore maintaining the original integrity of the desk/wall-mount telephone. The desired standard may include the same wireless standard as a user's cellular telephone. Each of the receive and transmit circuits may include an impedance matching transformer or capacitor-coupled and/or resistor-coupled amplifier between the base unit and the hands-free transceiver.

In some embodiments, the present invention provides a hands-free headset adapter, comprising a first connector to a base unit of a landline telephone; a second connector to couple to a handset of the landline telephone, the second connector coupled to the first connector via a communication channel; means for capturing first audio information from the communication channel; means for communicating second audio information based on the first audio information to a hands-free transceiver; and means for communicating third audio information based on the second audio information over a desired standard to a hands-free headset.

### BRIEF DESCRIPTION OF THE DRAWINGS

FIG. 1 illustrates several examples of landline telephones with hands-free headset adapters, in accordance with several embodiments.

FIG. 2 is a block diagram illustrating details of a hands-free headset adapter, in accordance with an embodiment.

FIG. 3 is a block diagram illustrating details of a hands-free headset adapter, in accordance with an embodiment.

FIG. 4 is a block diagram of an alternative impedance matching circuit, in accordance with an embodiment.

FIG. 5 is a block diagram of an interface for communicating with the landline telephone using rotary switches with a full-wave rectifier tap for recharging the battery, in accordance with an embodiment.

FIG. 6 is a block diagram of an interface for communicating with the landline telephone using discrete on/off switching, in accordance with an embodiment.

FIG. 7a is an elevational view of a hands-free headset adapter, in accordance with an embodiment.

FIG. 7b is a side view of a hands-free headset adapter, in accordance with an embodiment.

FIG. 7c is an end view of a hands-free headset adapter, in accordance with an embodiment.

FIG. 8 is a perspective view of a hands-free headset adapter, in accordance with an embodiment.

FIG. 9 is a flowchart illustrating a method for attaching a headset adapter to a landline telephone and for communicating audio information from the base unit of the landline telephone via the adapter 105 to a hands-free headset, in accordance with an embodiment.

FIG. 10 is a flowchart illustrating a method for attaching a headset adapter to a landline telephone and for communicating audio information from the hands-free headset via the adapter to the base unit of a landline telephone, in accordance with an embodiment.

### DETAILED DESCRIPTION

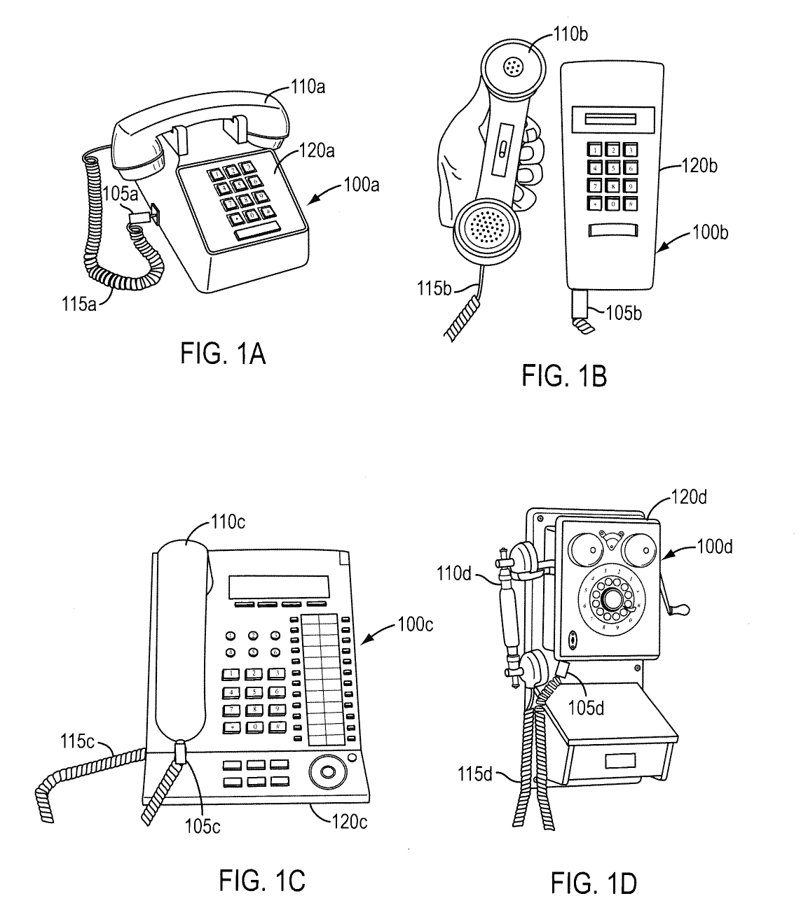

FIG. 1 illustrates several examples of landline telephones 100a-100d (each generally referred to herein as a landline telephone 100) equipped with hands-free headset adapters 105a-105d (each generally referred to herein as a hands-free headset adapter 105), in accordance with several embodiments. The hands-free headset adapter 105 enables the landline telephone 100 to communicate with a hands-free headset (not shown, not supplied). In some embodiments, the hands-free headset adapter 105 enables the landline telephone 100 to communicate wirelessly, e.g., using a Bluetooth® standard, with the hands-free headset. Thus, a Bluetooth®-compliant headset adapter 105 can cooperate with the same Bluetooth®-compliant headset that the user owns for use with his or her Bluetooth®-compliant cellular telephone (not shown, not supplied). Also, the hands-free headset adapter 105 enables the landline telephone 100 to communicate over a wired connection, e.g., using conventional earbuds with speakerphone.

Although embodiments herein are being described with reference to wireless communication using the Bluetooth® standard, one skilled in the art will recognize that wireless embodiments may use another wireless standard. The term “standard” is used herein to mean a general rule set. It should not be interpreted to require a rule set blessed by a standard body.

Landline telephone 100 may include a POTS telephone, a VOIP phone, or other telephone that is incapable of using a desired standard to communicate with a hands-free headset that uses the desired standard. Landline telephone 100 may include a rotary-dial telephone 100d or a tone-dial telephone 100a-100c. Landline telephone 100 may include a corded phone or cordless phone with the proper telephone connector (e.g., RJ-9).

As shown, landline telephone 100 includes a handset 110a-110d (generally referred to herein as handset 110) coupled via a handset cord 115a-115d (generally referred to herein as handset cord 115) to a base unit 120a-120d (generally referred to herein as base unit 120).

As shown, the hands-free headset adapter 105 may be coupled to the landline telephone 100 between the base unit 120 and the handset cord 115. Alternatively or additionally, the hands-free headset adapter 105 may be coupled to the landline telephone 100 between the handset cord 115 and the handset 110. In other embodiments, the hands-free headset adapter 105 may be retrofitted or manufactured within the base unit 120 and/or within the handset 110.

Further, embodiments may include multiple hands-free headset adapters 105 connected in series or parallel to enable communication over multiple hands-free devices and/or over multiple standards. Alternatively, a single headset adapter 105 can be manufactured to include multiple hands-free transceivers to enable communication over multiple desired standards. Other alternatives are possible.

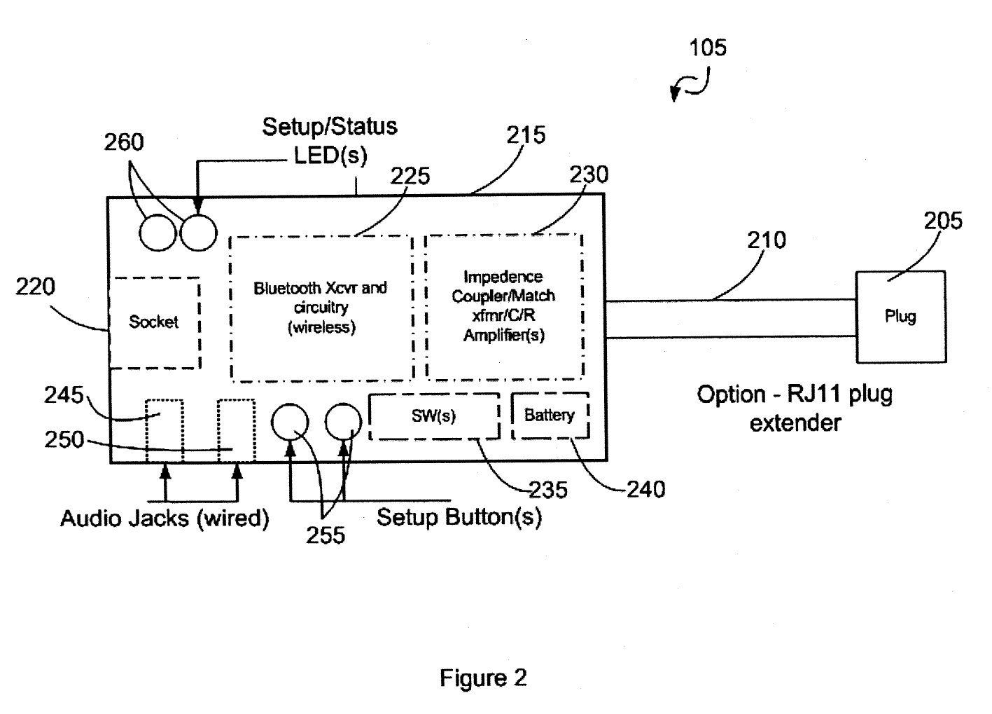

FIG. 2 is a block diagram of a hands-free headset adapter 105, in accordance with some embodiments. The headset adapter 105 includes a first connector 205 (e.g., a telephone plug such as an RJ-9 plug) coupled via an adapter cord 210 to a circuit board 215. The first connector 205 may be configured to couple to the base unit 120 or handset 110. The circuit board 215 includes a second connector (e.g., a telephone socket such as an RJ-9 socket), which may be configured to couple to the handset cord 115.

The circuit board 215 further includes a wireless transceiver 225, impedance coupler/matching transformer/capacitance/resistive amplifier(s) and battery charging circuitry 230, switches 235, a replaceable or rechargeable battery 240, a microphone jack 245 (for receiving a hands-free microphone), an earphone/speakerphone jack 250 (for receiving a wired earphone/speakerphone), one or more setup buttons 255, and one or more LEDs 260.

The switches 235 are configured to couple the wires within the landline telephone 100 to the wires within the headset adapter 105. The switches 235 allow reconfiguration of the interconnection of the wires to offer proper a transmit and receive arrangement. For recharging the battery 220, the switches 260 also include a DC tap.

The wireless transceiver 225 is configured to communicate over a desired wireless standard, e.g., the Bluetooth® standard, with the hands-free headset.

The microphone jack 245 and earphone/speakerphone jack 250, together forming a wired hands-free transceiver, are configured to provide a wired interface from the landline telephone 100 to a wired hands-free headset (not shown). The microphone jack 245 and earphone/speakerphone jack 250 communicate over a desired wired standard.

The impedance coupler/match circuitry 230 matches input and output impedances, e.g., between the base unit 120 and the wireless transceiver 225 and between the base unit 120 and the wired headset (not shown).

The buttons 255 control the wireless transceiver 225, e.g., to pair the transceiver 225 to the hands-free headset (not shown). In some embodiments, the buttons 255 may be part of the wireless transceiver 225.

The LEDs 260 communicate connection and operations status to the user. In some embodiments, the LEDs 260 may be part of the wireless transceiver 225.

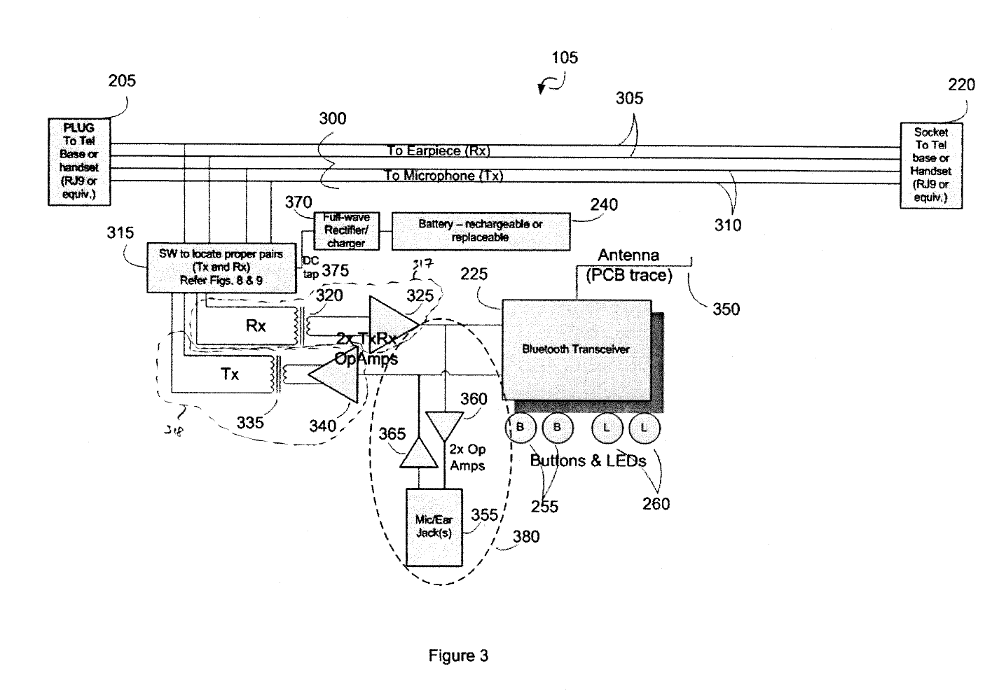

FIG. 3 is a block diagram illustrating details of a hands-free headset adapter 105, in accordance with some embodiments. The hands-free headset adapter 105 includes first connector 205 (labeled as “PLUG to Tel Base or handset (RJ-9 or equiv.)”) coupled via a communications channel 300 to the second connector 220 (labeled as “Socket to Tel Base or Handset (RJ-9 or equiv.)”). The communications channel 300 includes a receive wire or receiver wire pair 305 for communicating audio information received from the first connector 205 to the local user, e.g., via the second connector 220 to the earpiece on the handset 110. The communications channel 300 also includes a transmit wire or transmit wire pair 310 for communicating audio information to the remote user via the first connector 205, e.g., from the microphone on the handset 110 via the second connector 220.

As shown, the hands-free headset adapter 105 further includes switches 315 coupled in parallel to the communications channel 300 and connecting the appropriate receive and transmit wire or wire pairs 305 and 310 on communication channel 300. In some embodiments, the switches 315 are coupled to the communications channel 300 using two sets of four wires.

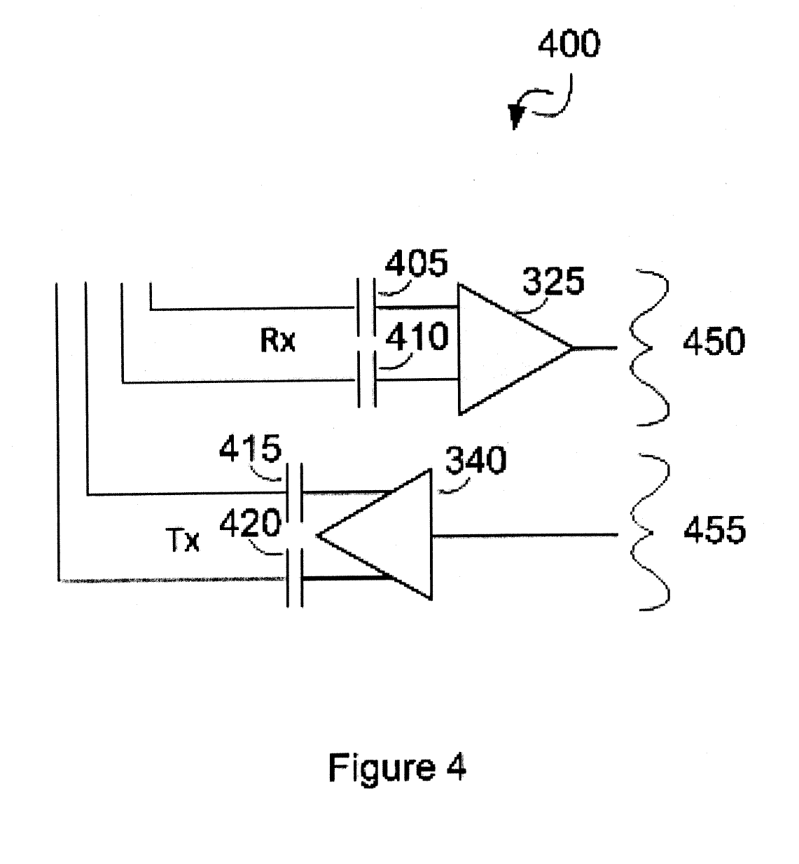

The hands-free headset adapter 105 further includes a receive circuit 317 and a transmit circuit 318. In the illustrated embodiment, the receive circuit 317 includes transformer 320 coupled to receive the incoming audio signal from the switches 315. The receive circuit 317 further includes an operational amplifier 325 coupled to receive and amplify the incoming audio signal from the transformer 320 and to transmit the amplified incoming audio signal to the wireless transceiver 225 (labeled as “Bluetooth® transceiver”). The transmit circuit 318 includes an operational amplifier 340 coupled to receive and amplify the audio signals from the wireless transceiver 225. The transmit circuit 318 further includes a transformer 335 coupling the amplified audio signals from the operational amplifier 340 to the switches 315. The receive and transmit circuits 317 and 318 provide impedance matching and high impedance to the original handset audio signals. One skilled in the art will recognize that other impedance matching circuits can be used. For example, instead of transformers 320 and 335, capacitors and/or resistors can be used. An example using capacitors is shown in FIG. 4.

The wireless transceiver 225 includes one or two buttons 255 for controlling the wireless transceiver 225 and one or two LEDs 260 for communicating connection and operations status to the user. The buttons 255 enable the user to pair the headset adapter 105 with the hands-free headset using conventional techniques and other operational choices.

The headset adapter 105 also includes a wired transceiver 380 in parallel with the wireless transceiver 225. The wired transceiver 380 includes microphone/earphone jacks 355 coupled to the receive and transmit circuits 317 and 318. The microphone/earphone jacks 355 may be coupled to the receive and transmit circuits 317 and 318 via a pair of operational amplifiers 360 and 365. The operational amplifier 365 may be coupled to act as a pre-amp to the transmit amplifier 340 of the transmit circuit 318. The operational amplifier 360 may be coupled to act as a post-amp to the receive amplifier 325 of the receive circuit 317.

The headset adapter 105 further includes a full wave rectifier charger 370 coupled to a DC tap 375 on the switches 315 for charging the rechargeable battery 240.

FIG. 4 is a block diagram illustrating an alternative impedance matching circuit 400, in accordance with an embodiment. Impedance matching circuit 400 includes a receive circuit 450 and a transmit circuit 455. The receive circuit 450 includes a pair of capacitors 405 and 410 coupled to the input of an operational amplifier 325. The transmit circuit 455 includes a pair of capacitors 415 and 420 coupled to the output of an operational amplifier 340.

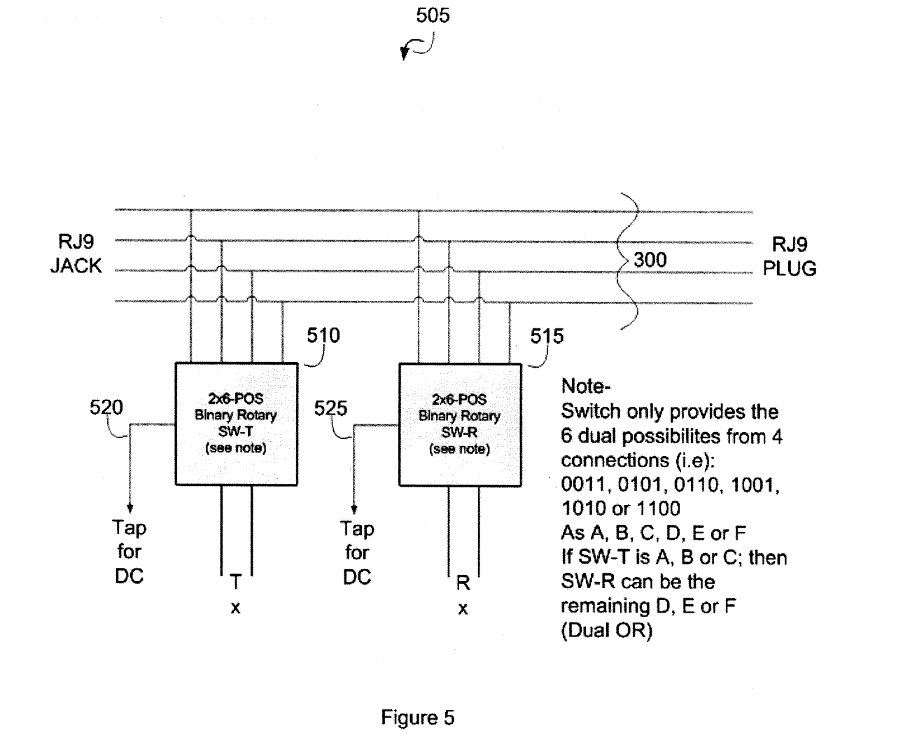

FIG. 5 is a block diagram of a tap interface 505 for communicating with the communication channel 300, in accordance with some embodiments. The tap interface 505 includes a 2×6 position binary rotary switch 510 for coupling the transmit wire pair 310 of the communication channel 300 to the transmit circuit 318, and a 2×6 position binary rotary switch 515 for coupling the receive wire pair 305 of the communication channel 300 to the receive circuit 317. Further, the transmit rotary switch 510 includes a DC tap 520 and the receive rotary switch 515 includes a DC tap 525, each for battery recharging.

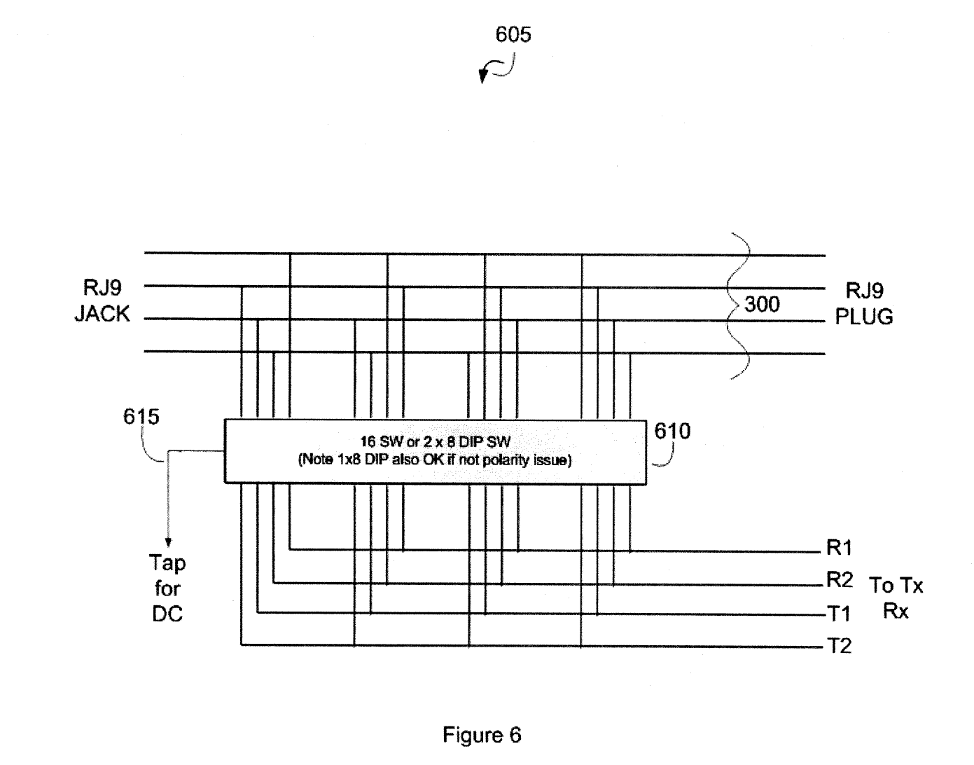

FIG. 6 is a block diagram of a tap interface 605 for communicating with the communication channel 300, in accordance with some embodiments. The tap interface 605 includes switches 610, which include two 2×8 switches or one 16 switch. The switches 610 are configured to couple the communication channel 300 to the receive and transmit circuits 317 and 318, e.g., the receive wire pair 305 to a wire pair (R1 and R2) connected to the receive circuit 317 and the transmit wire pair 310 to a wire pair (T1 and T2) connected to the transmit circuit 318. Further, the tap interface 605 includes a DC tap 615 for battery recharging.

Other tap interfaces 505/605 are also possible.

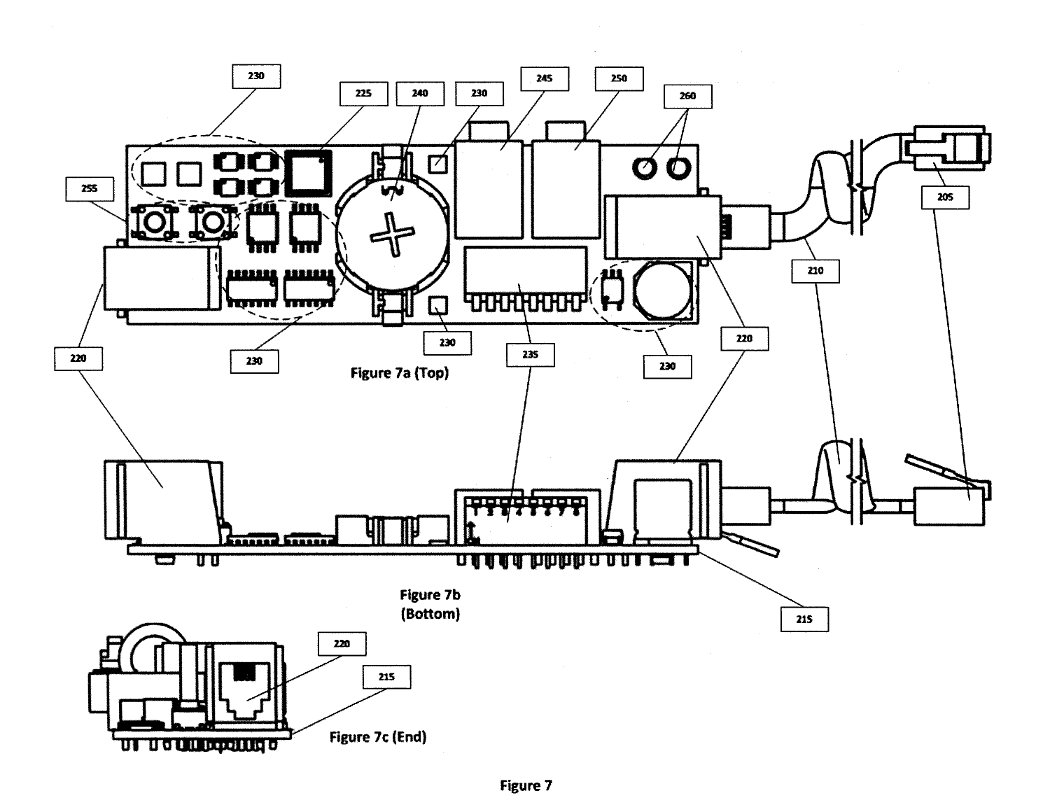

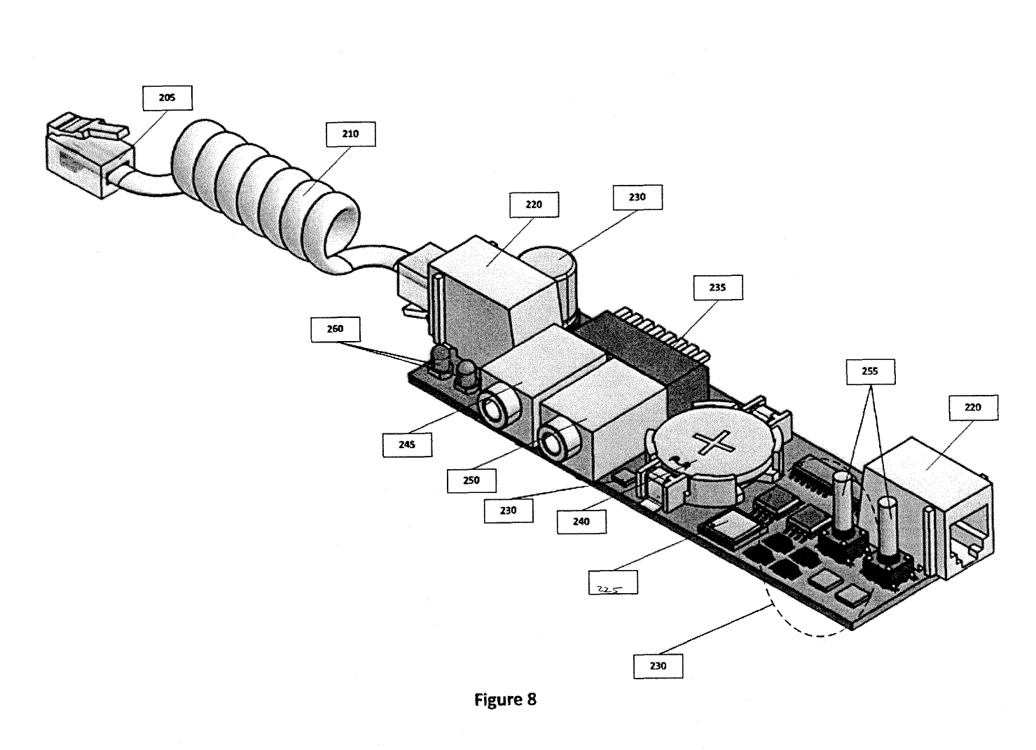

FIG. 7a is a top elevational view of a hands-free headset adapter 105, in accordance with an embodiment. The headset adapter 105 includes a first connector 205 (e.g., a telephone plug such as an RJ-9 plug) coupled via an adapter cord 210 to a circuit board 215. The circuit board 215 includes a second connector (e.g., a telephone socket such as an RJ-9 socket), which may be configured to couple to the handset cord 115. The circuit board 215 further includes a wireless transceiver 225, impedance coupler/matching transformer/capacitance/resistive amplifier(s) and battery charging circuitry 230, switches 235, a replaceable or rechargeable battery 240, a microphone jack 245 (for receiving a hands-free microphone), an earphone/speakerphone jack 250 (for receiving a wired earphone/speakerphone), one or more setup buttons 255, and one or more LEDs 260. FIG. 7b is a side view of the hands-free headset adapter 105, in accordance with an embodiment. FIG. 7c is an end view of the hands-free headset adapter 105, in accordance with an embodiment. FIG. 8 is a perspective view of the hands-free headset adapter 105, in accordance with an embodiment.

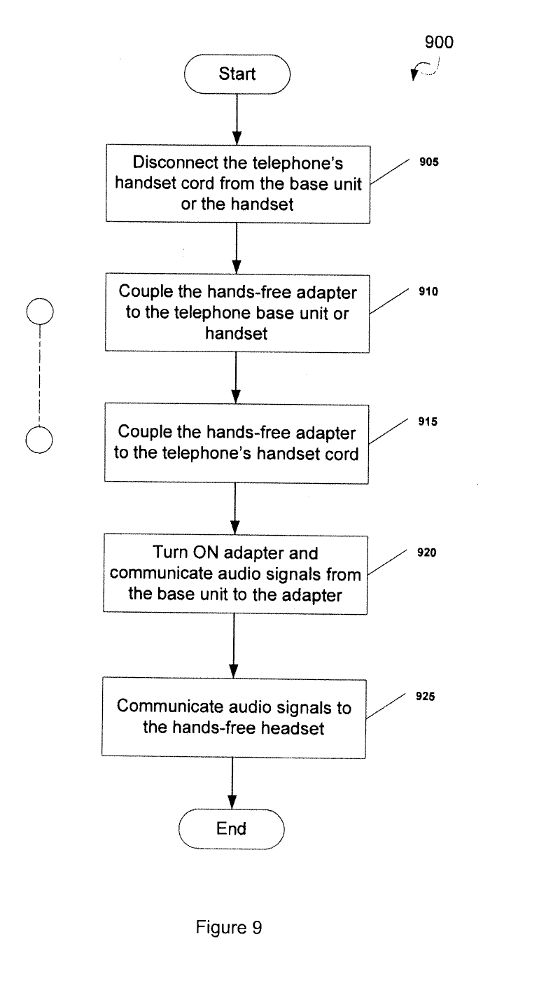

FIG. 9 is a flowchart illustrating a method 900 for attaching a headset adapter 105 to a landline telephone 100 and for communicating audio information from the base unit 120 via the adapter 105 to a hands-free headset, in accordance with an embodiment. The method 900 begins in step 905 by disconnecting the telephone's handset cord 115 from the base unit 120 or the handset 110. In step 910, the headset adapter 105 is coupled to the base unit 120 or the handset 110, e.g., via the first connector 205. In step 915, the headset adapter 105 is coupled to the handset cord 115, e.g., via the second connector 220. In step 920, the adapter 105 is activated, and audio information is communicated from the base unit 120 to the adapter 105. In step 925, audio information is transmitted from the adapter 105 over the desired standard to the hands-free headset. Method 900 then ends.

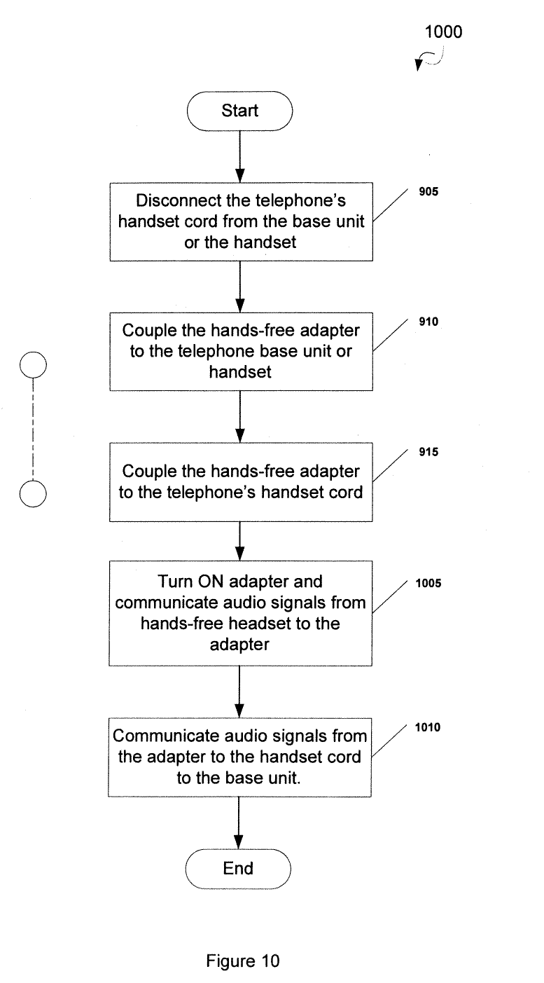

FIG. 10 is a flowchart illustrating a method for attaching a headset adapter 105 to a landline telephone 100 and for communicating audio information from the hands-free headset via the adapter 105 to the base unit 120 of a landline telephone 100, in accordance with an embodiment. The method 1000 begins in step 905 with the telephone's handset cord 115 being disconnected from the base unit 120 or the handset 110. In step 910, the headset adapter 105 is coupled to the base unit 120 or the handset 110, e.g., via the first connector 205. In step 915, the headset adapter 105 is coupled to the handset cord 115, e.g., via the second connector 220. In step 1005, audio information is communicated from the hands-free headset over the desired standard to the adapter 105. In step 1010, the audio information is transmitted from the adapter 105 to the handset cord 115 and thus to the base unit 120 of the landline telephone 100. Method 1000 then ends.

It will be appreciated that the typical POTS/VOIP desk/wall-mount telephone with a hand-held handset will be in use for many more years. Many people have purchased or received with their cellular/mobile wireless telephone a wired and/or wireless hands-free device so the cellular/mobile phone does not need to be held to the ear. This device in this application provides the use of this hands-free microphone/earphone to be used with the standard telephone.

The foregoing description of the preferred embodiments is by way of example only, and other variations and modifications of the above-described embodiments and methods are possible in light of the foregoing teaching. The various embodiments set forth herein may be implemented utilizing hardware, software, or any desired combination thereof. For that matter, any type of logic may be utilized which is capable of implementing the various functionality set forth herein. Components may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

1. A hands-free headset adapter, comprising:
a first telephone connector configured to couple with the base unit of a landline telephone;
a second telephone connector configured to couple with the handset of the landline telephone, the second telephone connector coupled to the first telephone connector via a communication channel;
receive and transmit circuits coupled to the communication channel and configured to receive and transmit audio information with the base unit of the landline telephone; and
a hands-free transceiver coupled to the receive and transmit circuits and configured to communicate over a desired standard with a hands-free headset.

2. The hands-free headset adapter of claim 1, wherein the first telephone connector includes a 3-position (3P) or 4-position (4P) telephone connector.

3. The hands-free headset adapter of claim 2, wherein the first telephone connector includes a telephone plug.

4. The hands-free headset adapter of claim 2, wherein the first telephone connector includes a telephone socket.

5. The hands-free headset adapter of claim 1, wherein the second connector is configured for receiving a handset cord.

6. The hands-free headset adapter of claim 1, wherein the desired wireless standard includes the Bluetooth® standard.

7. The hands-free headset adapter of claim 1, wherein the desired wireless standard includes the same standard as a user's cellular telephone.

8. The hands-free headset adapter of claim 1, wherein each of the receive and transmit circuits includes an impedance matching circuit coupled between the base unit and the hands-free transceiver.

9. The hands-free headset adapter of claim 1, wherein the hands-free transceiver includes audio jacks configured to connect to a hands-free wired headset.

10. The hands-free headset adapter of claim 1, further comprising switches for selecting the wire connection configuration between the communication channel and the receive and transmit circuits.

11. A method comprising:
using a first connector to couple a hands-free headset adapter to a base unit of a landline telephone, the hands-free headset adapter including receive and transmit circuits and a hands-free transceiver capable of communicating over a desired standard;
using a second connector to couple the hands-free headset adapter to the handset of the landline telephone, the second connector coupled to the first connector via a communication channel;
capturing first audio information from the communication channel by the receive circuit;
communicating second audio information based on the first audio information captured by the receive circuit to the hands-free transceiver; and
using the hands-free transceiver to communicate third audio information based on the second audio information over the desired standard to a hands-free headset.

12. The method of claim 11, wherein the first telephone connector includes a 3-position (3P) or 4-position (4P) telephone connector.

13. The method of claim 12, wherein the first telephone connector includes a telephone plug.

14. The method of claim 12, wherein the first telephone connector includes a telephone socket.

15. The method of claim 11, wherein the second connector is configured for receiving a handset cord.

16. The method of claim 11, wherein the desired wireless standard includes the Bluetooth® standard.

17. The method of claim 11, wherein the desired wireless standard includes the same standard as a user's cellular telephone.

18. The method of claim 11, wherein each of the receive and transmit circuits includes an impedance matching circuit with an amplifier coupled between the base unit and the hands-free transceiver.

19. The method of claim 11, wherein the hands-free transceiver includes audio jacks configured to connect to a hands-free wired headset.

20. The method of claim 11, wherein the hands-free headset includes switches for selecting the wire connection configuration between the telephone connector and the receive and transmit circuits, and further comprising setting the switches.

21. The method of claim 11, further comprising:
communicating fourth audio information from the hands-free headset over the desired standard to the hands-free transceiver;
communicating fifth audio information based on the fourth audio information from the hands-free transceiver to the transmit circuit; and
communicating sixth audio information based on the fifth audio information from the transmit circuit to the communication channel.

22. A hands-free headset adapter, comprising:
a first connector to a base unit of a landline telephone;
a second connector to couple to a handset of the landline telephone, the second connector coupled to the first connector via a communication channel;
means for capturing first audio information from the communication channel;
means for communicating second audio information based on the first audio information to a hands-free transceiver; and
means for communicating third audio information based on the second audio information over a desired standard to a hands-free headset.
